(19) United States
(12) Patent Application Publication
(10) Pub. No.: US 2026/0281756 A1
(43) Pub. Date: Sep. 17, 2026

(54) CHANNEL STATUS INFORMATION PROCESSING METHOD AND APPARATUS, COMMUNICATION DEVICE AND STORAGE MEDIUM

(71) Applicant: Beijing Xiaomi Mobile Software Co., Ltd., Beijing (CN)

(72) Inventors: Yajun ZHU, Beijing (CN); Zhongyuan ZHAO, Beijing (CN); Yifan CAI, Beijing (CN)

(73) Assignee: Beijing Xiaomi Mobile Software Co., Ltd., Beijing (CN)

(21) Appl. No.: 18/877,655

(22) PCT Filed: Jun. 30, 2022
(86) PCT No.: PCT/CN2022/103151

§ 371 Date: Dec. 20, 2024

(51) Int. Cl. H04W 24/08; H04W 24/10

(52) U.S. Cl. CPC H04W 24/08; H04W 24/10

(57) ABSTRACT

A method for processing channel status information (CSI) is performed by a terminal and includes: performing, based on a CSI prediction result, at least one of: reference signal (RS) measurement, or CSI reporting.

### CROSS REFERENCE TO RELATED APPLICATIONS

This application is a National Phase of International Application No. PCT/CN2022/103151, filed on Jun. 30, 2022, the entire contents of which are incorporated herein by reference in their entireties.

### TECHNICAL FIELD

The present disclosure relates to but not limited to the field of wireless communication technologies and in particular to a method for processing channel status information (CSI), an apparatus for processing CSI, a communication device and a storage medium.

### BACKGROUND

In the related arts, a User Equipment (UE) measures CSI of a channel and reports the CSI to a network side such that the network side, for example, a base station, can know a status of the channel and hence can schedule data transmission resources and the like.

The UE or base station may predict the CSI of a future time so as to configure resource scheduling in advance.

### SUMMARY

Embodiments of the present disclosure provide a method for processing channel status information (CSI), an apparatus for processing CSI, a communication device and a storage medium.

According to a first aspect of the embodiments of the present disclosure, there is provided a method for processing channel status information (CSI), performed by a terminal and including:
performing, based on a CSI prediction result, at least one of: reference signal (RS) measurement, or CSI reporting.

According to a second aspect of the embodiments of the present disclosure, there is provided a method for processing channel status information (CSI), performed by a base station and including:
obtaining a CSI prediction result, where the CSI prediction result is for at least one of: reference signal (RS) measurement, or CSI reporting.

According to a third aspect of the embodiments of the present disclosure, there is provided a communication device, including: a processor; and a memory storing programs executable by the processor; where the programs, when executed by the processor, cause the processor to perform the method for processing CSI of the first or second aspect.

According to a fourth aspect of the embodiments of the present disclosure, there is provided a computer storage medium, storing executable programs thereon, where the executable programs, when executed by a processor, cause the processor to perform method for processing CSI of the first or second aspect.

It should be understood that the above general descriptions and subsequent detailed descriptions are illustrative and explanatory rather than limiting of the present disclosure.

### BRIEF DESCRIPTION OF THE DRAWINGS

The drawings incorporated into the specification and constituting a part of the specification illustrate the embodiments of the present disclosure and together with the specification, serve to interpret the principle of the embodiments of the present disclosure.

FIG. 1 is a structural schematic diagram illustrating a wireless communication system according to an embodiment of the present disclosure.

FIG. 2 is a schematic flowchart illustrating a method for processing CSI according to an embodiment of the present disclosure.

FIG. 3 is a schematic diagram illustrating a method for processing CSI according to an embodiment of the present disclosure.

FIG. 4 is a schematic flowchart illustrating a method for processing CSI according to an embodiment of the present disclosure.

FIG. 5 is a schematic flowchart illustrating a method for processing CSI according to an embodiment of the present disclosure.

FIG. 6 is a schematic flowchart illustrating a method for processing CSI according to an embodiment of the present disclosure.

FIG. 7 is a schematic flowchart illustrating a method for processing CSI according to an embodiment of the present disclosure.

FIG. 8 is a schematic flowchart illustrating a method for processing CSI according to an embodiment of the present disclosure.

FIG. 9 is a schematic flowchart illustrating a method for determining start time according to an embodiment of the present disclosure.

FIG. 10 is a structural schematic diagram illustrating an apparatus for processing CSI according to an embodiment of the present disclosure.

FIG. 11 is a structural schematic diagram illustrating an apparatus for processing CSI according to an embodiment of the present disclosure.

FIG. 12 is a structural schematic diagram illustrating a terminal according to an embodiment of the present disclosure.

FIG. 13 is a structural schematic diagram illustrating a communication device according to an embodiment of the present disclosure.

### DETAILED DESCRIPTION OF THE EMBODIMENTS

Examples will be described in detail herein, with the illustrations thereof represented in the drawings. Where the following description relates to the drawings, unless otherwise indicated, the same numerals in different drawings represent the same or similar elements. Implementations described in the following examples do not represent all implementations consistent with the present disclosure. On the contrary, they are examples of an apparatus and a method consistent with some aspects of the present disclosure described in detail in the appended claims.

The terms used in the present disclosure are for the purpose of describing a particular example only, and are not intended to limit the present disclosure. As used herein, the singular forms “a”, “said” and “the” are intended to include the plural forms as well, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

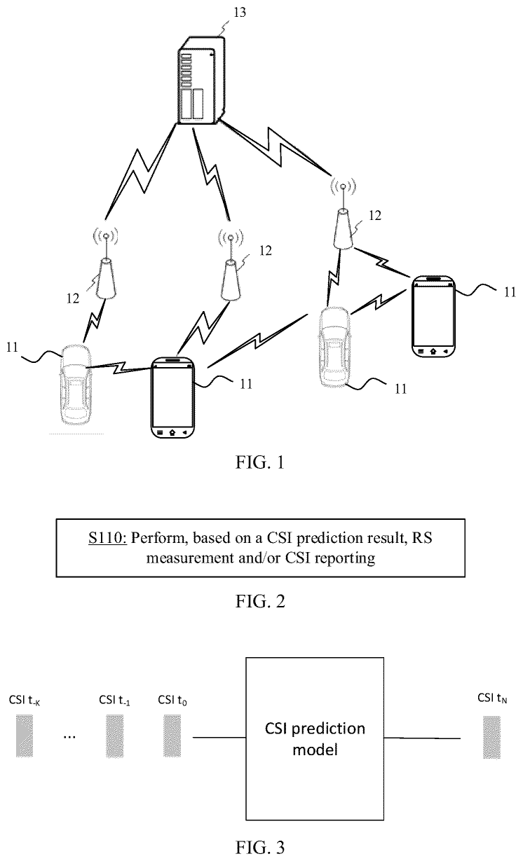

FIG. 1 is a schematic structural diagram illustrating a wireless communication system according to an embodiment of the present disclosure. As shown in FIG. 1, the wireless communication system is a communication system based on the cellular mobile communication technology, which may include a plurality of terminals 11 and a plurality of access devices 12.

The terminal 11 may be a device that provides voice and/or data connectivity to users. The terminal 11 can communicate with one or more core networks via a radio access network (RAN). The terminal 11 can be an IoT terminal, such as a sensor device, a mobile phone (or a “cellular” phone) and a computer with an IoT terminal. For example, it can be a fixed, portable, pocket-sized, handheld, computer-built or on-board device. For example, a station (STA), a subscriber unit, a subscriber station, a mobile station, a remote station, an access point, a remote terminal, an access terminal, a user terminal, a user agent, a user device or a user equipment (UE). Alternatively, the terminal 11 may be a device of an unmanned aerial vehicle. Alternatively, the terminal 11 may also be an on-board device, for example, a driving computer with wireless communication function, or a wireless communication device externally connected to the driving computer. Alternatively, the terminal 11 may also be a roadside device, such as a street lamp, a signal lamp or other roadside device with wireless communication function.

The access device 12 may be a network device in a wireless communication system. The wireless communication system can be the 4th (4G) generation mobile communication system, also known as long term evolution (LTE) system. Alternatively, the wireless communication system can also be a 5G system, also known as a new radio (NR) system or a 5G NR system. Alternatively, the wireless communication system can also be a next generation system of the 5G system. The access network in the 5G system can be called a new generation-radio access network (NG-RAN). Or, a machine type communication (MTC) system.

The access device 12 may be an evolved access device (eNB) adopted in the 4G system. Alternatively, the access device 12 may also be an access device (gNB) adopting a centralized and distributed architecture in the 5G system. When the access device 12 adopts a centralized and distributed architecture, the base station 12 usually includes a central unit (CU) and at least two distributed units (DUs). The centralized unit is provided with a protocol stack of packet data convergence protocol (PDCP) layer, radio link control (RLC) layer and media access control (MAC) layer. The distributed unit is provided with a physical (PHY) layer protocol stack. The embodiments of the present disclosure does not limit the specific implementation of the access device 12.

A wireless connection can be established between the access device 12 and the terminal 11 through a wireless air interface. In different embodiments, the wireless air interface is based on the fourth generation (4G) mobile communication network technology standard. Alternatively, the wireless air interface is based on the fifth generation (5G) mobile communication network technology standard, for example, the wireless air interface is a new radio. Alternatively, the wireless air interface can also be a wireless air interface based on the technical standard of the next generation mobile communication network of 5G.

In some embodiments, the wireless communication system may further include a network management device 13. A plurality of access devices 12 are respectively connected with a network management device 13. The network management device 13 may be a core network device in a wireless communication system. For example, the network management device 13 may be a mobility management entity (MME) in an evolved packet core (EPC). Alternatively, the network management device can also be other core network devices, such as serving gateway (SGW), public data network gateway (PGW), policy and charging rules function (PCRF) or home subscriber server (HSS). The embodiment of the present disclosure does not limit the implementation form of the network management device 13.

When measuring and reporting a measurement result, the UE usually performs measurement operation and reporting operation based on configuration information fixed by the base station, leading to excessively frequent or excessively sparse CSI measurement and reporting and generating unnecessary resource overhead and power consumption waste or leading to failure of the base station to obtain channel circumstance in time.

As shown in FIG. 2, an embodiment of the present disclosure provides a method for processing channel status information (CSI), performed by a terminal and including the following step S110.

At step S110, based on a CSI prediction result, reference signal (RS) measurement and/or CSI reporting is performed.

In an embodiment of the present disclosure, the CSI is channel status information for indicating a channel attribute of a communication link between the terminal and a base station. For example, the CSI may include at least one of a Channel Quality Indicator (CQI), a Rank Indicator (RI) and a Precoder Matrix Indicator (PMI).

RS is a reference signal for measuring and obtaining CSI, for example, the RS may be carried in CSI resource configuration information distributed by the base station. The CSI resource configuration information may be included in CSI reporting configuration information distributed by the base station. The CSI reporting configuration information may be used to indicate resource information used for the terminal to perform CSI measurement and CSI reporting. For example, the CSI resource configuration information and the CSI reporting configuration information may be carried in a Radio Resource Control (RRC) signaling and the like and distributed to the terminal.

Illustratively, the RS may be channel status information-Reference Signal (CSI-RS) or may be Synchronization Signal Block (SSB) or the like.

In an embodiment, the RS measurement may include: a periodic measurement and a non-periodic measurement. The periodic measurement may include a periodic measurement performed based on a period indicated by the base station, and may also include a semistatic measurement started and ended based on an activation instruction and a deactivation instruction distributed by the base station. The non-periodic measurement may be one measurement performed based on indication information distributed by the base station.

In an embodiment, the CSI reporting may include a periodic reporting and a non-periodic reporting. The periodic reporting may include a periodic reporting performed based on a period distributed by the base station, and may also include a semistatic reporting started and ended based on an activation instruction and a deactivation instruction distributed by the base station. The non-periodic reporting may be one reporting performed based on indication information distributed by the base station.

In an embodiment, the CSI prediction result may include at least one of: a CSI result predicted for one or more target times, a CSI result predicted for a target time period, a CSI time domain circumstance predicted for one or more target times, and a CSI time domain prediction circumstance predicted for a target time period.

The target time or target time period may be indicated by a base station configuration or determined by the terminal itself, for example, may be determined by the terminal based on a current time and/or on a predetermined protocol between the terminal and the base station. The CSI prediction result predicted for one or more target times or the target time period may be predicted based on CSI obtained by current measurement and/or CSI obtained by performing measurement within a preset time window prior to the current time. For example, prediction may be performed based on a preset Artificial Intelligence (AI) model and so on.

Illustratively, as shown in FIG. 3, based on a CSI prediction model, multiple CSIs: CSI t0, CSI t1, . . . CSI tk obtained by performing measurement at multiple historical times t0, t1, . . . tk are processed to obtain CSI tN predicted for one future target time tN.

In an embodiment, the CSI predicted for one or more target times or the target time period may also be predicted based on CSI obtained by current measurement and/or CSI obtained by performing measurement within a preset time window prior to the current time and current status information and/or information of the terminal.

In an embodiment, the CSI time domain prediction circumstance may include at least one of:
a CSI change circumstance over time, a suggested measurement period of RS and a suggested reporting period of CSI and the like. The CSI in the CSI time domain change circumstance may be CSI obtained by current RS measurement, or a CSI result predicted for one or more target times or the target time period and the like.

In an embodiment, the CSI change circumstance over time may include a CSI change rate within a preset time period. The preset time period may be a fixed value or a corresponding time period when a CSI change amplitude is predicted to reach a preset value.

Illustratively, the CSI change rate within the preset time period may include: if the CQI obtained by the current RS measurement is level 3, when it is predicted that the change amplitude reaches level 5, namely, when it is predicted that the CQI obtained by RS measurement is level 8, a change rate of the CQI from the current time to the time when it is predicted that the CQI obtained by RS measurement is level 8.

In an embodiment, the CSI prediction result may also include: predicted RS measurement frequency and/or CSI reporting frequency, or a valid time length of a predicted single RS measurement result and/or a valid time length of a single CSI reporting result and the like.

In an embodiment, the RS measurement may be a measurement performed for a channel status based on the RS to obtain CSI corresponding to the RS. The CSI reporting may be reporting the CSI obtained by the current RS measurement to the base station.

In an embodiment, the CSI prediction result may also include a valid time length of the CSI reported at the target time. The target time may be a current time or a time following the current time. The valid time length may represent a time length for which the CSI reported at the target time can continuously indicate the channel status, and the valid time length may be represented by a specific time length or a number of time units. For example, when the valid time length is 10 s, it indicates that, within 10 s from the target time, the CSI reported at the target time can indicate the channel status within the 10 s.

For example, the time unit may be a slot. When the valid time length is 100 slots, it indicates that, within 100 slots from the target time, the CSI reported at the target time can indicate the channel status within the 100 slots.

In an embodiment, the valid time length may also be indicated by a valid time length Identity Document (ID) configured by RRC in advance, for example, ID #1 represents 50 slots, ID #2 represents 100 slots, and ID #3 represents 200 slots and the like.

Illustratively, the terminal may, by reporting ID #2, indicate that the valid time length is 100 slots.

In an embodiment, the CSI prediction result may be predicted by the terminal itself or may be a CSI prediction result received from the base station. For example, the step S110 may include: performing RS measurement based on an RS measurement period indicated by the CSI prediction result transmitted by the base station, and/or performing CSI reporting based on a CSI reporting period indicated by the CSI prediction result transmitted by the base station.

The suggested measurement period of RS and/or the suggested reporting period of CSI may be directly indicated by the CSI prediction result or determined based on the valid time length indicated by the CSI prediction result. For example, the suggested measurement period of RS and/or the suggested reporting period of CSI may be equal to the valid time length or less than the valid time length, or have a preset relationship with the valid time length.

Illustratively, when the valid time length is 10 s, the suggested measurement period of RS and/or the suggested reporting period of CSI may be 10 s or 8 s or ½ of the valid time length, i.e. 5 s, or the like.

In an embodiment, the suggested measurement period of RS and/or the suggested reporting period of CSI may also be represented by a number of slots, for example, the suggested measurement period of RS and/or the suggested reporting period of CSI may be 5 slots or 10 slots or the like.

In an embodiment, based on the valid time length reported by the terminal, within a valid time length following one reporting of the CSI, data transmission of the current terminal or another terminal is performed by using a time frequency resource for transmitting RS and/or reporting CSI. Within the valid time length following one reporting of the CSI, the terminal may neglect at least part of the periodic measurement of RS and/or at least part of periodic reporting of CSI.

Illustratively, the CSI reporting period indicated by first CSI reporting configuration information (CSI Report Config #1) is 40 slots, which means CSI reporting is performed at the 11th slot, 51st slot and 91st slot respectively. The CSI reporting period indicated by second CSI reporting configuration information (CSI Report Config #2) is 80 slots, which means CSI reporting is performed at the 11th slot and 91st slot respectively. When the valid time length in the CSI prediction result is 100 slots, the CSI reporting of the 11th slot and 51st slot in the CSI reporting period corresponding to the CSI Report Config #1 can be neglected.

In an embodiment, when receiving, within the valid time length, a non-periodic CSI reporting instruction distributed by the base station, the terminal can perform non-periodic CSI reporting.

Illustratively, the terminal reports the valid time length of 100 slots at the first slot, and receives, at the 81st slot, a non-periodic CSI reporting instruction distributed by the base station, and thus the terminal can report the CSI as indicated by the base station, for example, report the CSI at the 85th slot, with the CSI prediction result included in the reported CSI.

In an embodiment, the step S110 may also include: transmitting the CSI prediction result to the base station; based on the suggested measurement period of RS and/or suggested reporting period of CSI indicated by the base station based on the CSI prediction result, performing RS measurement and/or CSI reporting. For example, the CSI prediction result may also indicate the valid time length, and hence based on the suggested measurement period of RS and/or suggested reporting period of CSI determined by the base station based on the valid time length, RS measurement and/or CSI reporting can be performed.

For another example, the CSI prediction result can indicate the suggested measurement period of RS and/or suggested reporting period of CSI determined based on the valid time length. After a preset instruction of the base station for indicating acknowledgement for the suggested measurement period of RS and/or suggested reporting period of CSI is received, RS measurement and/or CSI reporting is performed based on the suggested measurement period of RS and/or suggested reporting period of CSI.

In an embodiment, the step S110 may also include: transmitting the CSI prediction result to the base station; after the CSI prediction result is transmitted to the base station, performing RS measurement and/or CSI reporting based on the CSI prediction result.

In an embodiment, the suggested measurement period of RS and/or suggested reporting period of CSI may be determined by the terminal based on the valid time length, or based on the valid time length, determined by the terminal from multiple candidate RS measurement periods and/or multiple candidate CSI reporting periods indicated by the base station. For example, RS measurement and/or CSI reporting may be performed based on a candidate RS measurement period and/or candidate CSI reporting period equal to the valid time length or with a minimal difference with the valid time length.

Therefore, determining the suggested measurement period of RS and/or suggested reporting period of CSI in combination with the CSI valid time length can reduce the unnecessary RS measurement and/or CSI reporting frequently generated due to improper configuration of the suggested measurement period of RS and/or suggested reporting period of CSI, thereby lowering the resource overhead and power consumption.

Illustratively, the candidate CSI reporting periods indicated by the base station include 5 s, 8 s and 10 s. When the valid time length is 10 s, the candidate CSI reporting period of 10s can be selected as the suggested reporting period of CSI.

Illustratively, the resource configuration information transmitted by the base station via RRC to the terminal in advance indicates the candidate RS periods and/or candidate CSI reporting periods, which includes the followings: the first index value index #1 represents the RS period and/or the CSI reporting period is 5 slots, and the second index value index #2 represents the RS period and/or CSI reporting period is 10 slots. If the terminal selects the suggested period of RS and/or the suggested reporting period of CSI as 10s based on the valid time length, the terminal can transmit the second index value to the base station to reduce the reported data volume and help the base station to know the period value selected by the terminal.

Therefore, with prediction on the CSI of a future time, the RS measurement behaviors and CSI reporting behaviors determined based on the CSI prediction result can better match the change of the CSI prediction. Thus, depending on change of the CSI prediction result, the RS measurement and CSI reporting behaviors can be adjusted flexibly, for example, an operation period or frequency or the like can be adjusted. Therefore, the flexible of the terminal in performing RS measurement operation and CSI reporting operation can be increased, and high resource overhead and power consumption waste resulting from low control accuracy for the measurement operation and the reporting operation can be reduced.

In some embodiments, the CSI prediction result may include at least one of:
a valid time length of the CSI reported at the target time;
a suggested measurement period of RS; or
a suggested reporting period of CSI.

Herein, the target time may be a next time for reporting CSI, or a time when CSI reporting is completed currently. For example, based on at least one of the current time, the time of reporting CSI last prior to the current time, and the CSI reporting period in the CSI prediction result, the next time for reporting CSI can be determined.

In an embodiment, the valid time length of the CSI reported at the target time can be determined based on the CSI reported at the current time or the last-reported CSI prior to the current time. For example, based on the last-reported CSI of the CSI prediction target time prior to the current time as well as the predicted CSI of the target time, the valid time length of the CSI reported at the target time can be determined.

In an embodiment, the valid time length of the CSI reported at the target time can also be determined based on multiple historically-reported CSIs of the CSI prediction target time prior to the current time and the predicted CSI of the target time.

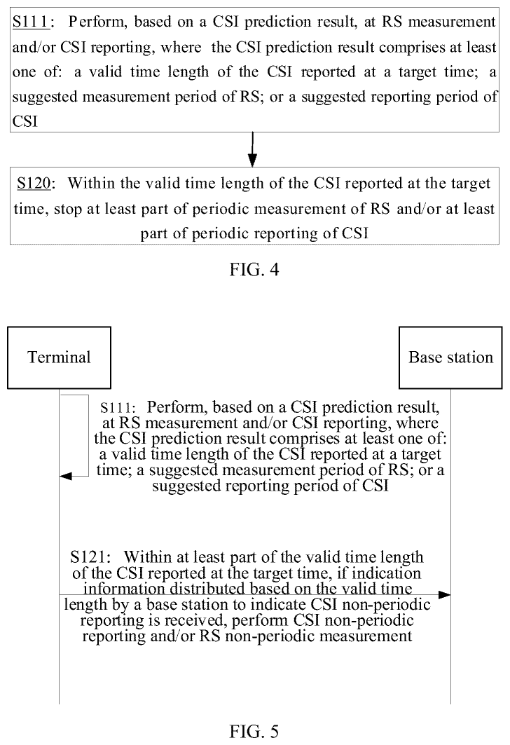

As shown in FIG. 4, an embodiment of the present disclosure provides a method for processing CSI which is executed by a terminal. The method for processing CSI may include the following steps S111 and S120.

At step S111, based on a CSI prediction result, RS measurement and/or CSI reporting is performed; the CSI prediction result includes at least one of: a valid time length of CSI reported at a target time; a suggested measurement period of RS; and a suggested reporting period of CSI.

At step S120, within the valid time length of the CSI reported at the target time, at least part of periodic measurement of RS and/or at least part of periodic reporting of CSI are stopped.

In an embodiment of the present disclosure, the valid time length may be used as a report quantity of the CSI reporting, namely, it can be reported by the terminal to a base station. Within the valid time length after performing CSI reporting at the target time, the reported CSI can be considered as continuously representing channel status, and thus within the valid time length, it is not required to continue RS measurement and/or CSI reporting.

In an embodiment, within the valid time length of the CSI reported at the target time, stopping at least part of periodic measurement of RS and/or at least part of periodic reporting of CSI may include: within at least part of the valid time length of the CSI reported at the target time, stopping at least part of periodic measurement of RS and/or at least part of periodic reporting of CSI.

In an embodiment, stopping at least part of periodic measurement of RS and/or at least part of periodic reporting of CSI may include: stopping the periodic measurement and/or periodic reporting of other times than the last RS measurement time and/or CSI reporting time within the valid time length.

Herein, the terminal performs CSI reporting/RS measurement based on the last CSI periodic reporting time and/or RS measurement time within the valid time length of the target time.

In another embodiment, stopping at least part of periodic measurement of RS and/or at least part of periodic reporting of CSI may include: stopping all periodic CSI reporting and/or all periodic RS measurement within the valid time length of the target time, and performing CSI reporting and/or RS measurement when receiving indication information for indicating CSI reporting from the base station within the valid time length.

Herein, the indication information may be downlink control information (DCI) including a non-periodic CSI reporting instruction.

In an embodiment, the method may further include:
within the valid time length of the CSI reported at the target time, reporting the CSI based on the indication information of the base station.

In an embodiment of the present disclosure, reporting and/or measurement indicated by the indication information of the base station is still performed within the valid time length. If receiving the indication information of the base station, the terminal obtains an RS based on the indication information and performs RS measurement and CSI reporting.

Obtaining the RS based on the indication information may be obtaining the RS indicated by the indication information, or obtaining the RS by transmitting a request to the base station based on the indication information or the like. The indication information may be DCI distributed by the base station, for example, the indication information may be used to indicate the terminal to report the CSI.

In an embodiment, the method may also include: within the valid time length of the CSI reported at the target time, if the indication information for indicating RS measurement is received from the base station, RS measurement is performed.

In an embodiment, for example, the suggested measurement period of RS is determined based on the valid time length, and the suggested measurement period of RS is greater than or equal to the valid time length. Hence, within one suggested measurement period or one valid time length after the CSI is reported based on the target time, if the indication information for RS measurement is received from the base station, RS measurement is performed.

In an embodiment, for example, the suggested measurement period of RS is determined based on the valid time length, and the suggested measurement period of RS is less than the valid time length. Hence, within one suggested measurement period after the CSI is reported based on the target time, if the indication information for RS measurement is received from the base station, RS measurement is performed.

In an embodiment, for example, the suggested reporting period of CSI is determined based on the valid time length, and the suggested reporting period of CSI is greater than or equal to the valid time length. Hence, within one suggested reporting period or one valid time length after the CSI is reported based on the target time, if the indication information for CSI reporting is received from the base station, CSI reporting is performed.

In an embodiment, for example, the suggested reporting period of CSI is determined based on the valid time length, and the suggested reporting period of CSI is less than the valid time length. Hence, within one suggested reporting period after the CSI is reported based on the target time, if the indication information for CSI reporting is received from the base station, CSI reporting is performed.

Therefore, within the valid time length, the periodic CSI reporting can be shielded, but the non-periodic CSI reporting based on the indication of the base station can still be responded to. In this way, on the basis of reducing the unnecessary non-periodic reporting, response to the instruction of the base station for obtaining the CSI can be maintained, reducing the failure of the base station to obtain the CSI at the time of need.

As shown in FIG. 5, an embodiment of the present disclosure provides a method for processing CSI, which is executed by a terminal. The method for processing CSI includes the following steps S111 and S121.

At step S111, based on a CSI prediction result, RS measurement and/or CSI reporting is performed; the CSI prediction result includes a valid time length of CSI reported at a target time.

At step S121, within at least part of the valid time length of the CSI reported at the target time, if indication information distributed based on the valid time length by a base station to indicate CSI non-periodic reporting is received, CSI non-periodic reporting and/or RS non-periodic measurement is performed.

Herein, the indication information may be DCI including a non-periodic CSI reporting instruction. The CSI non-periodic reporting indicated by the indication information may be reporting CSI or reporting CSI and CSI prediction result.

In an embodiment of the present disclosure, the indication information distributed by the base station based on the valid time length may be indication information distributed by the base station at a distribution time determined based on the valid time length. For example, a time interval between the distribution time and the current time or the last CSI reporting time prior to the current time may be less than or equal to the valid time length.

In an embodiment, the indication information distributed by the base station based on the valid time length may also be indication information distributed by the base station to indicate a to-be-reported CSI time determined based on the valid time length. For example, a time interval between the to-be-reported CSI time and the current time or the last CSI reporting time prior to the current time may be less than or equal to the valid time length.

Illustratively, when the base station reports the CSI with the CSI valid time length of 10 slots at the 1st slot, the base station can distribute the indication information at the 9th slot to indicate the terminal perform one non-periodic CSI reporting.

In an embodiment, the RS periodic measurement may include an RS continuous periodic measurement, for example, an RS periodic measurement continuously performed based on the measurement period configured by the base station, or the RS periodic measurement may also include an RS semistatic measurement, for example, the semistatic measurement may be an RS periodic measurement started based on a start instruction indicated by the base station and ended based on an ending instruction indicated by the base station.

In an embodiment, the CSI periodic reporting may include a CSI continuous periodic reporting, for example, a CSI periodic reporting continuously performed based on a reporting period configured by the base station, or the CSI periodic reporting may also include a CSI semistatic reporting, for example, the semistatic reporting may be a CSI periodic reporting started based on a start instruction indicated by the base station and ended based on an ending instruction indicated by the base station.

In an embodiment, if the suggested measurement period of RS is determined based on the valid time length, when the suggested measurement period of RS is greater than or equal to the valid time length, the RS periodic measurement can be stopped within one suggested measurement period or one valid time length after the CSI is reported based on the target time.

In an embodiment, if the suggested measurement period of RS is determined based on the valid time length, when the suggested measurement period of RS is less than the valid time length, the RS periodic measurement can be stopped within one suggested measurement period after the CSI is reported based on the target time.

In an embodiment, if the suggested reporting period of CSI is determined based on the valid time length, when the suggested reporting period of CSI is greater than or equal to the valid time length, the CSI periodic reporting can be stopped within one suggested reporting period or one valid time length after the CSI is reported based on the target time.

In an embodiment, if the suggested reporting period of CSI is determined based on the valid time length, when the suggested reporting period of CSI is less than the valid time length, the CSI periodic reporting can be stopped within one suggested reporting period after the CSI is reported based on the target time.

In this case, within the valid time length in which the CSI continuously represents the channel status, performing RS periodic measurement and/or CSI periodic reporting can be stopped such that the CSI validity within the valid time length can be fully used to reduce the power consumption generated by frequent performing of the periodic measurement and periodic reporting.

In some embodiments, the method further includes transmitting a CSI prediction result to the base station.

Herein, the terminal can be used to perform CSI prediction to obtain a CSI prediction result and transmit the CSI prediction result to the base station. The CSI prediction result transmitted to the base station can be used to suggest to the base station a suggested period in which the terminal performs next RS measurement and/or CSI reporting. The value of the suggested period may be a number of time units or a period ID or a period index indicated in configuration information of the RS periodic measurement and/or CSI periodic reporting configured by RRC or the like.

In an embodiment, transmitting the CSI prediction result to the base station may be reporting the CSI prediction result with CSI to the base station. For example, after the CSI prediction result is obtained by prediction, the CSI prediction result is carried in a CSI reporting signaling and then reported to the base station during a next CSI reporting.

For example, the contents carried by the CSI reporting signaling corresponding to the CSI reporting may include: the CSI obtained by current RS measurement and CSI prediction result.

In an embodiment, transmitting the CSI prediction result to the base station may be reporting the CSI prediction result by a medium access control-control element (MAC-CE) in response to a request for reporting the CSI prediction result from the base station. For example, by the MAC-CE, the suggested measurement period of RS and/or suggested reporting period of CSI is transmitted.

In an embodiment, transmitting the CSI prediction result to the base station may also be a request message carrying the CSI prediction result and transmitted by the terminal to the base station or the like. For example, the request message is used to suggest to the base station the measurement period and/or reporting period.

In some embodiments, based on the CSI prediction result, performing RS measurement and/or CSI reporting includes:

if receiving a preset instruction returned by the base station in response to the CSI prediction result, performing RS measurement and/or CSI reporting based on the CSI prediction result and/or preset instruction.

In an embodiment, the preset instruction may be associated with a manner in which the CSI prediction result is transmitted to the base station. For example, when the CSI prediction result is reported to the base station by the CSI reporting signaling, the received preset instruction may be resource configuration information for indicating RS measurement behaviors and/or CSI reporting behaviors of the terminal.

Illustratively, the resource configuration information may carry the RS measurement period and/or CSI reporting period determined by the base station based on the CSI prediction result. The measurement period and/reporting period indicated by the base station may be same as the suggested measurement period and/or suggested reporting period in the CSI prediction result transmitted by the terminal, or a measurement period and/or reporting period re-determined by the base station after determining the suggested measurement period and/or suggested reporting period in the CSI prediction result as unreasonable.

In an embodiment, when the terminal reports the prediction result by the MAC-CE, the preset instruction may be an Acknowledge (ACK) instruction of the base station for a Physical Uplink Shared Channel (PUSCH) including the MAC-CE.

Herein, the ACK instruction may be transmitted to the terminal implicitly, for example, a new uplink scheduling is initiated by using a hybrid automatic repeat request (HARQ) process ID same as carrying the above PUSCH. New data indicator (NDI) domain is reversed, which means a new uplink scheduling.

In an embodiment, when the terminal reports the CSI prediction result by the request message, the preset instruction may be an ACK instruction or a Non-Acknowledge (NACK) instruction or the like returned by the base station based on the request message. The ACK may indicate that the base station determines the terminal performs measurement and/or reporting based on the suggested measurement period and/or suggested reporting period in the CSI prediction result. The NACK may indicate that the base station determines the suggested measurement period and/or suggested reporting period in the CSI prediction result is unreasonable and indicate the terminal to re-determine the suggested measurement period and/or suggested reporting period and the like.

In an embodiment, if receiving the preset instruction returned by the base station in response to the CSI prediction result, performing RS measurement and/or CSI reporting based on the CSI prediction result and/or preset instruction includes: if receiving a first-class preset instruction returned by the base station in response to the CSI prediction result, performing RS measurement and/or CSI reporting based on the CSI prediction result, where the first-class preset instruction indicates that the base station successfully verifies the suggested measurement period and/or suggested reporting period in the CSI prediction result, for example, ACK.

In an embodiment, the method may further include: if receiving a second-class preset instruction returned by the base station in response to the CSI prediction result, re-determining the CSI prediction result and transmitting the re-determined CSI prediction result to the base station, where the second-class preset instruction indicates that the base station unsuccessfully verifies the suggested measurement period and/or suggested reporting period in the CSI prediction result, for example, NACK.

In an embodiment, if receiving the preset instruction returned by the base station in response to the CSI prediction result, performing RS measurement and/or CSI reporting based on the CSI prediction result and/or preset instruction may include: if receiving indication information indicating a non-periodic CSI reporting and returned by the base station in response to the valid time length in the CSI prediction result, performing RS measurement and/or CSI reporting based on the indication information.

For example, based on the non-periodic CSI reporting time indicated by the indication information, RS measurement and/or CSI reporting is performed.

In an embodiment, when the terminal reports the CSI prediction result by the request message, the preset instruction may also be feedback information carried in another signaling, for example, carried in non-periodic measurement indication information distributed by the base station to indicate the terminal to perform RS measurement, and/or ACK or NACK or the like in the non-periodic reporting indication information for indicating the terminal to report CSI. Thus, by carrying the feedback information in another signaling, the resource overhead generated by the base station distributing ACK or NACK separately can be reduced, so as to further reduce resource occupation.

In some embodiments, transmitting the CSI prediction result to the base station includes:
if there is an available CSI reporting resource within a preset time window, reporting the CSI and the CSI prediction result;
if there is no available CSI reporting resource within the preset time window, reporting the CSI and the CSI prediction result based on the indication information of the base station.

Herein, reporting the CSI and the CSI prediction result based on the indication information of the base station may be reporting the CSI and the CSI prediction result based on further indication information distributed by the base station. For example, based on the indication information indicating the non-periodic CSI reporting and distributed by the base station, the CSI and the CSI prediction result are reported.

In an embodiment of the present disclosure, the preset time window may be a fixed value, for example, 3 slots or 5 slots or the like, or the preset time window may also be determined based on a reporting period for reporting the CSI currently. For example, the preset time window may be less than or equal to the current CSI reporting period. Illustratively, when the current CSI reporting period is 6 slots, the preset time window may be ½ of the current CSI reporting period, i.e. 3 slots.

In an embodiment, if no available CSI reporting resource is present within the preset time window, reporting the CSI and the CSI prediction result based on the indication information of the base station may include: if no available CSI reporting resource for the periodic CSI reporting is present within the preset time window and the indication information indicating the non-periodic CSI reporting and distributed by the base station is received, generating a request message based on the CSI and the CSI prediction result; and reporting the request message to the base station.

Thus, based on the determination on whether to-be-reported CSI is present within the preset time window, the case that the prediction result can be reported only at the reporting time corresponding to the periodic CSI reporting can be avoided, increasing the efficiency. Therefore, the CSI prediction result can be reported quickly and efficiently at different times, which increases the efficiency of the terminal measurement and/reporting control.

In some embodiments, based on the CSI prediction result, performing RS measurement and/or CSI reporting includes:
based on a first time of receiving the preset instruction and/or a second time of reporting the CSI last prior to the current time, determining a start time of the RS measurement and/or CSI reporting;
based on the suggested measurement period and the start time, performing RS measurement and/or based on the suggested reporting period and the start time, performing CSI reporting.

In an embodiment of the present disclosure, the start time of the RS measurement may be a next time of performing measurement following the current time, or may be a start time of performing measurement based on the suggested measurement period and/suggested reporting period in the CSI prediction result.

The start time of the CSI reporting may be a next time of performing reporting following the current time, or may be a start time of performing reporting based on the suggested reporting period in the CSI prediction result.

In an embodiment, based on the first time of receiving the preset instruction and/or the second time of reporting the CSI last prior to the current time, determining the start time of the RS measurement and/or CSI reporting may include: based on the second time of reporting the CSI last prior to the current time and the suggested reporting period in the CSI prediction result, determining the start time of the CSI reporting.

For example, the second time is the m-th slot, and a new reporting period indicated by the CSI prediction result is x slots, and thus the start time of the CSI reporting is the (m+x)-th slot.

In an embodiment, based on the first time of receiving the preset instruction and/or the second time of reporting the CSI last prior to the current time, determining the start time of the RS measurement and/or CSI reporting may include: based on the first time and/or the second time and a predetermined time interval, determining the start time of the RS measurement and/or CSI reporting.

Illustratively, based on the first time of receiving the preset instruction and the predetermined time interval, the start time of the RS measurement and/or CSI reporting is determined. For example, the first time is the n-th slot. The predetermined time interval may be determined based on the resource configuration information distributed by the base station or on a predetermined protocol, for example, the preset time interval is y slots and thus the start time is the (n+y)-th slot.

For another example, based on the second time of reporting the CSI last prior to the current time and the predetermined time interval, the start time of the RS measurement and/or CSI reporting is determined. For example, the second time is the m-th slot and the predetermine time interval is y slots, and thus the start time is the (m+y)-th slot.

In an embodiment, based on the first time of receiving the preset instruction and/or the second time of reporting the CSI last prior to the current time, determining the start time of the RS measurement and/or CSI reporting may include: when the terminal reports the CSI prediction result to the base station by a request message, based on the first time of receiving the ACK distributed by the base station and/or the second time of reporting the CSI last prior to the current time, determining the start time of the RS measurement and/or CSI reporting.

In an embodiment, based on the first time of receiving the preset instruction and/or the second time of reporting the CSI last prior to the current time, determining the start time of the RS measurement and/or CSI reporting may include: when the terminal reports the CSI prediction result to the base station by a CSI reporting signaling, based on the first time of receiving the CSI resource configuration information distributed by the base station and/or the second time of reporting the CSI last prior to the current time, determining the start time of the RS measurement and/or CSI reporting.

In this way, based on the first time and/or the second time, the start time corresponding to performing based on new measurement period and/or reporting period can be determined more accurately, further improving the control accuracy of the CSI processing procedure.

In some embodiments, the method may further include:
obtaining at least one to-be-predicted time of to-be-predicted CSI; and
based on the CSI obtained by current RS measurement, determining a CSI prediction result corresponding to the to-be-predicted time.

In an embodiment of the present disclosure, the to-be-predicted time is a time to predict the CSI following the current time. Based on the CSI obtained by current RS measurement, determining the CSI prediction result corresponding to the to-be-predicted time may include: based on the CSI obtained by current RS measurement and historical CSI obtained based on at least one historical RS measurement, determining the CSI prediction result corresponding to the to-be-predicted time.

Herein, the CSI obtained by current RS measurement may be CSI obtained by performing RS measurement at the current time, or CSI obtained by performing the last RS measurement prior to the current time.

In an embodiment, based on the CSI obtained by current RS measurement, determining the CSI prediction result corresponding to the to-be-predicted time may include: based on the CSI obtained by current RS measurement, determining the CSI corresponding to the to-be-predicted time; based on the CSI corresponding to the to-be-predicted time, determining the CSI prediction result corresponding to the to-be-predicted time.

For example, based on the CSI corresponding to the to-be-predicted time, a valid time length of the CSI corresponding to the to-be-predicted time, and corresponding suggested measurement period of RS and suggested reporting period of CSI and the like are determined.

In some embodiments, the CSI prediction result may be reported to the base station by MAC-CE, or uplink control information (UCI).

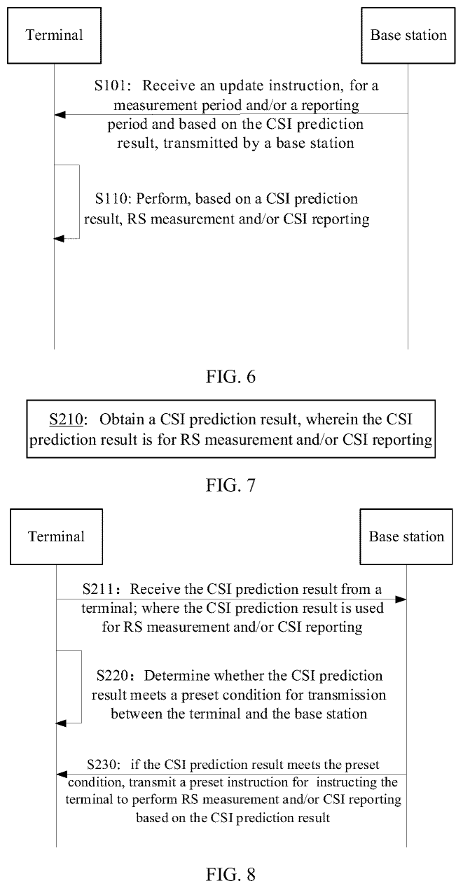

As shown in FIG. 6, an embodiment of the present disclosure provides a method for processing CSI, which is executed by a terminal. The method for processing CSI includes the following steps S101 and S110.

At step S101, an update instruction, for a measurement period and/or reporting period and based on a CSI prediction result, transmitted by a base station is received.

At step S110, based on the CSI prediction result, RS measurement and/or CSI reporting is performed.

In an embodiment of the present disclosure, the update instruction may be used to indicate the terminal to update a measurement period of the RS measurement and/or a reporting period of the CSI reporting based on the CSI prediction result. The update instruction may be only used to indicate triggering the update of the terminal, and may also carry the CSI prediction result obtained by the base station through prediction, for example, the update instruction may carry the measurement period and/or reporting period obtained by the base station through prediction.

In an embodiment, the update instruction may be transmitted by the base station based on the CSI prediction result, for example, can carry a new measurement period and/or reporting period determined by the base station based on the CSI prediction result. Alternatively, the update instruction may also be an instruction by which the base station indicates the terminal to update the measurement period and/or reporting period based on the CSI prediction result.

In an embodiment, when the update instruction is used only to indicate triggering the update of the terminal, the method further includes: in response to the update instruction, performing prediction on the CSI of the to-be-predicted time to obtain the CSI prediction result.

In an embodiment, when the update instruction carries the CSI prediction result obtained by the base station through prediction, the step S110 may include: obtaining the RS measurement period and/or CSI reporting period indicated by the base station from the CSI prediction result carried in the update instruction; based on the RS measurement period and/or CSI reporting period, performing RS measurement and/or CSI reporting.

In some embodiments, the method may further include:
performing data transmission by a time domain resource and/or frequency domain resource for RS reception and/or CSI reporting.

In an embodiment of the present disclosure, performing data transmission by the time domain resource and/or frequency domain resource for RS reception and/or CSI reporting may include: in a time interval between two adjacent CSI reporting times corresponding to one reporting period, performing data transmission by the time domain resource and/or frequency domain resource for RS reception and/or CSI reporting.

In an embodiment, performing data transmission by the time domain resource and/or frequency domain resource for RS reception and/or CSI reporting may include: in a time interval between two adjacent CSI reporting times corresponding to one reporting period, if the indication information distributed by the base station to indicate starting a non-periodic CSI reporting is not detected, performing data transmission by the time domain resource and/or frequency domain resource for RS reception and/or CSI reporting.

In an embodiment, performing data transmission by the time domain resource and/or frequency domain resource for RS reception and/or CSI reporting may further include: in a time interval between two adjacent RS reception times corresponding to one or more reporting periods, performing data transmission by the time domain resource and/or frequency domain resource for RS reception and/or CSI reporting.

In this way, when the periodic CSI reporting is stopped in the reporting period, the time frequency resource not occupied for CSI reporting or RS distribution can be released for data to be transmitted between the transmission terminal and the base station, so as to improve the resource utilization efficiency and reduce the additional resource overhead and power consumption wastes.

As shown in FIG. 7, an embodiment of the present disclosure provides a method for processing CSI, which is executed by a base station. The method for processing CSI includes the following step S210.

At step S210, a CSI prediction result is obtained; the CSI prediction result is used for RS measurement and/or CSI reporting.

In an embodiment of the present disclosure, the CSI prediction result obtained by the base station may be a CSI prediction result determined by the base station itself or a CSI prediction result reported by a terminal. The CSI prediction result is used to indicate RS measurement and/or CSI reporting of the terminal, for example, the CSI prediction result can indicate a suggested measurement period of RS and/or suggested reporting period of CSI and the like for the terminal.

In an embodiment, the CSI prediction result may include: CSI predicted for one or more target times or a target time period, and/or CSI time domain prediction circumstance predicted for one or more target times or the target time period.

The target time or target time period may be determined by the base station itself or transmitted to the base station by the terminal, for example, the target time or target time period may be determined by the base station based on the current time and/or on a predetermined protocol between the base station and the terminal. The CSI predicted for one or more target times or target time period may be predicted based on the CSI obtained by current measurement and/or the CSI obtained by measurement within a preset time window prior to the current time. For example, the prediction can be performed based on a preset AI model and the like.

In an embodiment, the method may further include: based on a suggested measurement period of RS and a suggested reporting period of CSI indicated by the CSI prediction result, determining a transmitting period for transmitting an RS to the terminal; based on the transmitting period, transmitting the RS for RS measurement to the terminal. For example, the transmitting period of RS of the base station may be consistent with the suggested measurement period of RS of the terminal or with the suggested reporting period of CSI of the terminal or the like.

In an embodiment, when the base station itself determines the CSI prediction result by prediction, the method may further include: transmitting the CSI prediction result to the terminal, which may include, for example, transmitting an update instruction for an RS measurement period and/or CSI reporting period based on the CSI prediction result to the terminal and the like. The update instruction can carry the CSI prediction result.

In an embodiment, when the base station itself determines the CSI prediction result by prediction, the method may further include: verifying the CSI prediction result; if the CSI prediction result meets a preset condition, transmitting the CSI prediction result to the terminal. For example, when the RS measurement period and/or CSI reporting period indicated by the CSI prediction result meets the preset condition for transmission between the terminal and the base station, the CSI prediction result is transmitted to the terminal.

In an embodiment, when the CSI prediction result reported by the terminal is received, the method may further include: verifying the CSI prediction result; if the CSI prediction result meets the preset condition, transmitting a preset instruction for indicating performing RS measurement and/or CSI reporting based on the CSI prediction result to the terminal.

Therefore, the base station can indicate, based on the CSI prediction result configuration, the behaviors of the terminal for performing RS measurement and/or CSI reporting so as to match the CSI prediction change in a better way. Thus, depending on the change of the CSI prediction result, the behaviors of the RS measurement and/or CSI reporting can be adjusted flexibly, for example, the period or frequency or the like can be adjusted. In this way, the flexibility of performing measurement and reporting can be improved, and the high resource overhead and power consumption waste resulting from the low control accuracy for the measurement and reporting can be reduced.

In some embodiments, the CSI prediction result may include at least one of:
a valid time length of the CSI received at a target time;
a suggested measurement period of RS; or
a suggested reporting period of CSI.

As shown in FIG. 8, an embodiment of the present disclosure provides a method for processing CSI, which is executed by a base station. The method for processing CSI includes the following steps S211, S220 and S230.

At step S211, the CSI prediction result is received from a terminal; the CSI prediction result is used for RS measurement and/or CSI reporting.

At step S220, whether the CSI prediction result meets a preset condition for transmission between the terminal and the base station is determined.

At step S230, if the CSI prediction result meets the preset condition, a preset instruction for instructing the terminal to perform RS measurement and/or CSI reporting based on the CSI prediction result is transmitted.

In some embodiments, receiving the CSI prediction result from the terminal includes:
transmitting indication information; and
receiving CSI and the CSI prediction result reported by the terminal in response to the indication information.

In an embodiment of the present disclosure, the indication information may be indication information for indicating the terminal to report the CSI, for example, indication information for indicating the terminal to perform one non-periodic CSI reporting. The indication information may be DCI.

In an embodiment, receiving the CSI prediction result reported by the terminal in response to the indication information may be receiving the CSI prediction result reported together with the CSI by the terminal in response to the indication information. For example, after the base station receives the CSI prediction result obtained by the terminal through prediction, the CSI prediction result is carried in a CSI reporting signaling during a next CSI reporting.

For example, the contents carried by the CSI reporting signaling corresponding to the CSI reporting may include: the CSI obtained by current RS measurement and CSI prediction result.

In an embodiment, receiving the CSI prediction result reported by the terminal in response to the indication information may also include: receiving a request message carrying the CSI prediction result and reported by the terminal in response to the indication information or the like. For example, the request message is used to indicate the base station to verify the CSI prediction result to determine whether the measurement period and/or reporting period indicated by the CSI prediction result is reasonable.

In an embodiment, the preset instruction may be associated with a manner in which the base station receives the CSI prediction result transmitted by the terminal. For example, when the CSI prediction result transmitted by the terminal is received by the CSI reporting signaling, the preset instruction may be resource configuration information for indicating the RS measurement behavior and/or CSI reporting behavior of the terminal.

Illustratively, the resource configuration information may carry the RS measurement period and/or CSI reporting period determined by the base station based on the CSI prediction result. The measurement period and/reporting period indicated by the base station may be same as the suggested measurement period and/or suggested reporting period in the CSI prediction result transmitted by the terminal, or a measurement period and/or reporting period re-determined by the base station after determining the suggested measurement period and/or suggested reporting period in the CSI prediction result as unreasonable.

In an embodiment, when the CSI prediction result transmitted by the terminal is received by the request message, the preset instruction may be an Acknowledge (ACK) instruction or a Non-Acknowledge (NACK) instruction returned by the base station based on the request message.

The ACK may indicate that the base station determines the suggested measurement period and/or suggested reporting period in the CSI prediction result is reasonable, and indicate the terminal to perform measurement and/or reporting based on the suggested measurement period and/or suggested reporting period in the CSI prediction result.

The NACK may indicate that the base station determines the suggested measurement period and/or suggested reporting period in the CSI prediction result is unreasonable and indicate the terminal to re-determine the suggested measurement period and/or suggested reporting period and the like.

In an embodiment, when the CSI prediction result transmitted by the terminal is received by the request message, the preset instruction may also be feedback information carried in another signaling, for example, carried in non-periodic measurement indication information distributed by the base station to indicate the terminal to perform RS measurement, and/or ACK or NACK or the like indicating in the non-periodic reporting indication information for indicating the terminal to report CSI. Thus, by carrying the feedback information in another signaling, the resource overhead generated by the base station distributing ACK or NACK separately can be reduced, so as to further reduce resource occupation.

In some embodiments, the step S210 may include:
obtaining at least one to-be-predicted time of to-be-predicted CSI; and
based on currently-received CSI, determining a CSI prediction result corresponding to the to-be-predicted time.

In an embodiment of the present disclosure, the to-be-predicted time is a time when CSI is to be predicted following the current time. Based on the currently-received CSI, determining the CSI prediction result corresponding to the to-be-predicted time may include: based on the currently-received CSI and at least one historically-received historical CSI, determining the CSI prediction result corresponding to the to-be-predicted time.

Herein, the currently-received CSI may be CSI obtained by performing RS measurement at the current time, or CSI obtained by performing the last RS measurement prior to the current time.

In an embodiment, based on the currently-received CSI, determining the CSI prediction result corresponding to the to-be-predicted time may include: based on the currently-received CSI, determining the CSI corresponding to the to-be-predicted time; based on the CSI corresponding to the to-be-predicted time, determining the CSI prediction result corresponding to the to-be-predicted time.

For example, based on the CSI corresponding to the to-be-predicted time, a valid time length of the CSI corresponding to the to-be-predicted time, and corresponding RS measurement period and CSI reporting period and the like are determined.

In some embodiments, the CSI prediction result may be received by MAC-CE, or uplink control information (UCI).

In some embodiments, the method further includes:
transmitting to the terminal an update instruction for the measurement period and/or reporting period and based on the CSI prediction result.

In an embodiment of the present disclosure, the update instruction may be used to indicate the terminal to update a measurement period of the RS measurement and/or a reporting period of the CSI reporting based on the CSI prediction result. The update instruction may be only used to indicate triggering the terminal to determine a new measurement period and/or reporting period, and may also carry the CSI prediction result obtained by the base station through prediction, for example, the update instruction may carry the measurement period and/or reporting period obtained by the base station through prediction.

In some embodiments, the method may further include:
based on the suggested measurement period, determining a transmitting period of RS and based on the transmitting period, transmitting an RS to the terminal; and/or
receiving the CSI reported by the terminal based on the suggested reporting period.

In an embodiment of the present disclosure, the transmitting period of RS may be same as the suggested measurement period of RS or determined based on RS measurement rule and the suggested measurement period of RS. For example, if each transmitted RS is provided for the terminal to perform one measurement, the transmitting period of RS may be equal to the suggested measurement period. If each transmitted RS is provided for the terminal to perform two measurements, the transmitting period of RS may be double the suggested measurement period.

In some embodiments, the method may further include:
performing data transmission by a time domain resource and/or frequency domain resource for RS transmitting and/or CSI reception.

In an embodiment of the present disclosure, performing data transmission by the time domain resource and/or frequency domain resource for RS transmitting and/or CSI reception may include: in a time interval between two adjacent CSI reception times corresponding to one suggested reporting period of CSI, performing data transmission by the time domain resource and/or frequency domain resource for RS transmitting and/or CSI reception.

In an embodiment of the present disclosure, performing data transmission by the time domain resource and/or frequency domain resource for RS transmitting and/or CSI reception may include: in a time interval between two adjacent CSI reception times corresponding to one suggested reporting period of CSI, if the indication information for indicating starting a non-periodic CSI reporting is not distributed, performing data transmission by the time domain resource and/or frequency domain resource for RS transmitting and/or CSI reception.

In an embodiment, performing data transmission by the time domain resource and/or frequency domain resource for RS transmitting and/or CSI reception may also include: in a time interval between two adjacent RS transmitting times corresponding to one or more suggested reporting periods of CSI, performing data transmission by the time domain resource and/or frequency domain resource for RS transmitting and/or CSI reception.

For example, when each RS is provided for the terminal to perform multiple measurement, multiple CSI reporting periods may be included between two adjacent RS transmitting times.

Thus, in this way, when the periodic CSI reporting is stopped in the reporting period, the time frequency resource not occupied for CSI reporting or RS distribution can be released for data to be transmitted between the transmission terminal and the base station, so as to improve the resource utilization efficiency and reduce the additional resource overhead and power consumption wastes.

An embodiment of the present disclosure provides a method for processing CSI, which includes the following steps.
1. A user equipment (UE) reports a new CSI reporting content (including at least one of the following) to a base station.

### 1) One Set of CSI Values

Based on the configuration of the base station, the UE reporting includes a CSI result of a current measurement and a UE-predicted CSI prediction result of a future time period.

A to-be-predicted time corresponding to each CSI may be configured in advance by the base station or determined by the UE.

### 2) A Valid Time Length of the CSI

The valid time of the contents of this CSI reporting may be, for example, 1 s, 2 s or 5 s or the like.

Within the valid time length, the UE does not perform periodic or semistatic CSI reporting and measurement any longer: the base station can schedule data transmission of this user or another one on the configured RS distribution resource and/or CSI reporting resource.

If the base station triggers a non-periodic reporting within the valid time length, the UE still performs the non-periodic reporting.

### 3) A Suggested Reporting Period of CSI and/or a Measurement Period of RS as Well as a Predicted CSI Change Rate

2. Specifically, the method may further include the following steps:
1) Based on UE trigger, the value of the measurement period and/or reporting period is suggested by the UE and the base station determines whether the value is accepted.
2) If the value is accepted by the base station, the UE performs RS reception and/or CSI reporting based on a new measurement period and/or reporting period. The start time of the RS reception and/or CSI reporting is determined by one of the following methods:

If the ACK is received at the slot n after the x-th slot of receiving Ack, the UE receives CSI-RS and/or transmits CSI at the slot n+x.

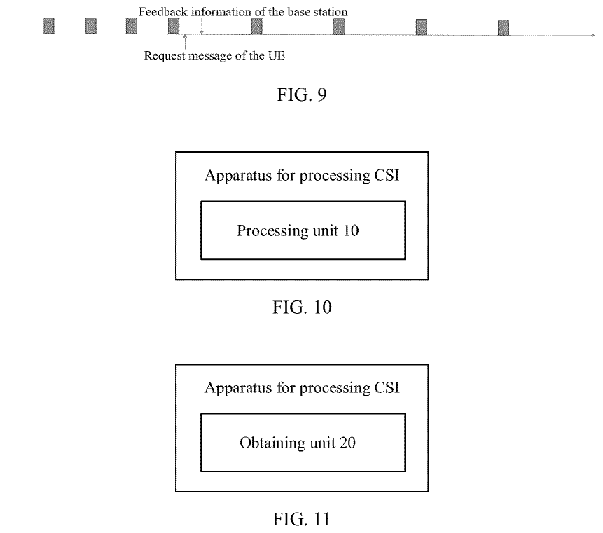

As shown in FIG. 9, the request message of the UE is a request message transmitted by the UE to the base station, and the feedback information gNodeB Acknowledge of the base station (gNB ACK) is ACK returned by the base station gNodeB (gNB) based on the request message. After x slots from the last RS reception and/or CSI reporting, it is supposed that the period is y (transmit CSI every other y slots) before the UE transmits the request message, the period suggested by the UE is x, and the slot that the UE transmits CSI last is n. In this case, the UE starts transmitting the CSI with the (n+x)-th slot as start time. The above method is also applicable to the determination of the start time of the RS reception.

As shown in FIG. 10, an embodiment of the present disclosure provides an apparatus for processing channel status information (CSI), applied to a terminal and including a processing unit 10.

The processing unit 10 is configured to perform, based on a CSI prediction result, at least one of: reference signal (RS) measurement, or CSI reporting.

In some embodiments, the CSI prediction result includes at least one of:
a valid time length of the CSI reported at a target time;
a suggested measurement period of RS; or
a suggested reporting period of CSI.

In some embodiments, the apparatus further includes a stopping unit.

The stopping unit is configured to: within the valid time length of the CSI reported at the target time, stop at least one of: at least part of periodic measurement of RS, or at least part of periodic reporting of CSI.

In some embodiments, the apparatus further includes a reporting unit.

The reporting unit is configured to: within the valid time length of the CSI reported at the target time, report the CSI based on indication information of a base station.

In some embodiments, the apparatus further includes a first transmitting unit.

The first transmitting unit is configured to: transmit the CSI prediction result to a base station.

In some embodiments, the processing unit 10 is specifically configured to: in response to receiving a preset instruction returned by the base station in response to the CSI prediction result, perform, based on at least one of: the CSI prediction result or the preset instruction, at least one of: the RS measurement, or the CSI reporting.

In some embodiments, the first transmitting unit is specifically configured to: in response to there being an available CSI reporting resource within a preset time window, report the CSI and the CSI prediction result; in response to there being no available CSI reporting resource within the preset time window, report the CSI and the CSI prediction result based on indication information of the base station.

In some embodiments, the processing unit 10 is specifically configured to: determine, based on at least one of: a first time of receiving the preset instruction or a second time of reporting the CSI last prior to a current time, a start time of at least one of: the RS measurement or the CSI reporting; and perform, based on the suggested measurement period and the start time, the RS measurement, and/or performing, based on the suggested reporting period and the start time, the CSI reporting.

In some embodiments, the apparatus further includes a prediction unit.

The prediction unit is configured to obtain at least one to-be-predicted time of to-be-predicted CSI; and determine, based on the CSI obtained by current RS measurement, a CSI prediction result corresponding to the to-be-predicted time.

In some embodiments, the CSI prediction result is reported to the base station by a medium access control-control element (MAC-CE), or uplink control information (UCI).

In some embodiments, the apparatus further includes a receiving unit.

The receiving unit is configured to receive an update instruction, for at least one of: a measurement period or a reporting period and based on the CSI prediction result, transmitted by a base station.

In some embodiments, the apparatus further includes a first transmission unit.

The first transmission unit is configured to perform, by at least one of: a time domain resource or a frequency domain resource for at least one of: receiving the RS or reporting the CSI, data transmission.

As shown in FIG. 11, an embodiment of the present disclosure provides an apparatus for processing channel status information (CSI), applied to a base station and including: an obtaining unit 20.

The obtaining unit 20 is configured to obtain a CSI prediction result, where the CSI prediction result is for at least one of: reference signal (RS) measurement, or CSI reporting.

In some embodiment, the CSI prediction result includes at least one of:
a valid time length of the CSI reported at a target time;
a suggested measurement period of RS; or
a suggested reporting period of CSI.

In some embodiments, the obtaining unit 20 is specifically configured to: receive the CSI prediction result transmitted by a terminal;

The apparatus further includes a second transmitting unit.

The second transmitting unit is configured to: determine whether the CSI prediction result meets a preset condition for transmission between the terminal and the base station; and in response to the CSI prediction result meeting the preset condition, transmit a preset instruction for instructing the terminal to perform, based on the CSI prediction result, at least one of: the RS measurement, or the CSI reporting.

In some embodiments, the obtaining unit 20 is specifically configured to: receive CSI and the CSI prediction result reported by the terminal; or receive a request message which is transmitted by the terminal to instruct to acknowledge the CSI prediction result.

In some embodiments, the obtaining unit 20 is specifically configured to: obtain at least one to-be-predicted time of to-be-predicted CSI; and determine, based on currently-received CSI, a CSI prediction result corresponding to the to-be-predicted time.

In some embodiments, the apparatus further includes an update unit.

The update unit is configured to: transmit an update instruction, for at least one of: a measurement period or a reporting period and based on the CSI prediction result, to a terminal.

In some embodiments, the apparatus further includes an interaction unit.

The interaction unit is configured to: determining, based on the suggested measurement period, a transmitting period of RS and transmitting, based on the transmitting period, the RS to a terminal; and/or receive the CSI reported by the terminal based on the suggested reporting period.

In some embodiments, the apparatus further includes a second transmission unit.

The second transmission unit is configured to: perform, by at least one of: a time domain resource or a frequency domain resource for at least one of: transmitting the RS or receiving the CSI, data transmission.

An embodiment of the present disclosure provides a communication device, including: a processor; and a memory storing programs executable by the processor; where the programs, when executed by the processor, cause the processor to perform the method of any one of the embodiments.

The processor may include various types of storage medium that are non-transitory computer storage medium capable of continuing to memorize information stored thereon after the user device is powered down.

Herein, the communication device includes a terminal or a network element, which can be any one of the first to fourth network elements.

The processor may be connected with the memory through a bus or the like for reading the executable programs stored on the memory, for example, at least one of the methods shown in FIG. 2, and 4 to 8.

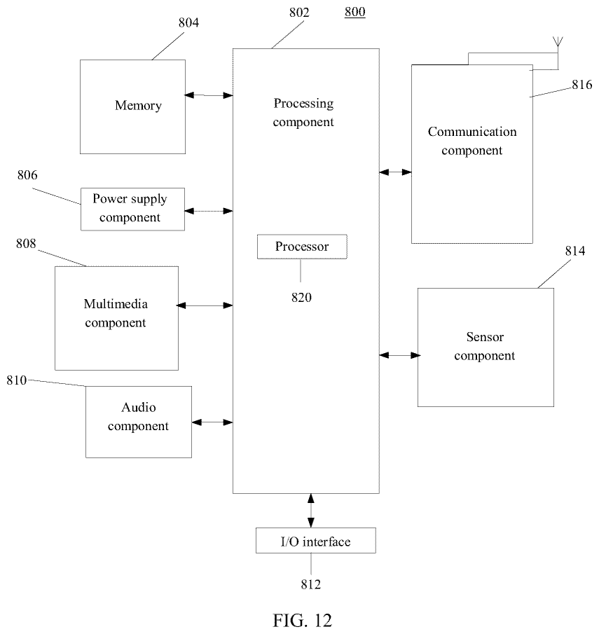

FIG. 12 is a block diagram illustrating a terminal according to an embodiment. For example, the terminal 800 may be a mobile phone, a computer, a digital broadcast UE, a message transmitting and receiving device, a game console, a tablet device, a medical device, a fitness device and a personal digital assistant and so on.

As shown in FIG. 12, the terminal 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls overall operations of the terminal 800, such as operations associated with display, phone calls, data communications, camera operations, and recording operations. The processing component 802 may include one or more processors 820 to execute instructions to complete all or a part of the steps of the above methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is to store various types of data to support the operation of the terminal 800. Examples of such data include instructions for any application or method operated on the terminal 800, contact data, phonebook data, messages, pictures, videos, and so on. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power supply component 806 supplies power for different components of the terminal 800. The power supply component 806 can include a power supply management system, one or more power supplies, and other components associated with generating, managing and distributing power for the terminal 800.

The multimedia component 808 includes a screen providing an output interface between the terminal 800 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 808 may include a front camera and/or a rear camera. The front camera and/or rear camera may receive external multimedia data when the terminal 800 is in an operating mode, such as a photographing mode or a video mode. Each of the front camera and the rear camera may be a fixed optical lens system or be of a focal length and a capability of an optical zoom.

The audio component 810 is configured to output and/or input an audio signal. For example, the audio component 810 includes a microphone (MIC). When the terminal 800 is in an operating mode, such as a call mode, a record mode and a voice recognition mode, the microphone is to receive an external audio signal. The received audio signal may be further stored in the memory 804 or sent via the communication component 816. In some examples, the audio component 810 also includes a speaker for outputting an audio signal.

The I/O interface 812 may provide an interface between the processing component 802 and peripheral interface modules. The above peripheral interface modules may include a keyboard, a click wheel, buttons and so on. Such buttons may include but not limited to: a home button, a volume button, a start button and a lock button.

The sensor component 814 includes one or more sensors to provide status assessments of various aspects for the terminal 800. For example, the sensor component 814 may detect an on/off status of the terminal 800 and a relative location of components. For example, the components are a display and a keypad of the terminal 800. The sensor component 814 may also detect a position change of the terminal 800 or a component of the terminal 800, presence or absence of a touch between a user and the terminal 800, an orientation or acceleration/deceleration of the terminal 800, and a temperature change of the terminal 800. The sensor component 814 may include a proximity sensor for detecting the existence of a nearby object without any physical touch. The sensor component 814 may also include a Complementary Metal-Oxide-Semiconductor (CMOS) or Charged Coupled Device (CCD) image sensor applied in an imaging application. In some examples, the sensor component 814 may also include an acceleration sensor, a gyro sensor, a magnetic sensor, a pressure sensor, or a temperature sensor.

The communication component 816 is to facilitate wired or wireless communication between the terminal 800 and other devices. The terminal 800 can access a wireless network based on a communication standard, such as Wi-Fi, 2G or 3G, or a combination thereof. In examples, the communication component 816 receives a broadcast signal or broadcast related information from an external broadcast management system via a broadcast channel. In examples, the communication component 816 may also include a Near Field Communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology and other technologies.

In examples, the terminal 800 may be implemented by one or more of application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the method as shown in any one of FIGS. 2 and 4 to 8.

In an example, a non-transitory computer readable storage medium including instructions, such as the memory 804 including instructions, is also provided. The above instructions may be executed by the processor 820 of the terminal 800 to complete the above method. For example, the non-transitory computer readable storage medium may be a read-only memory (ROM), a random access memory (RAM), a CD-ROM, a magnetic tape, a floppy disk and an optical data storage device, etc.

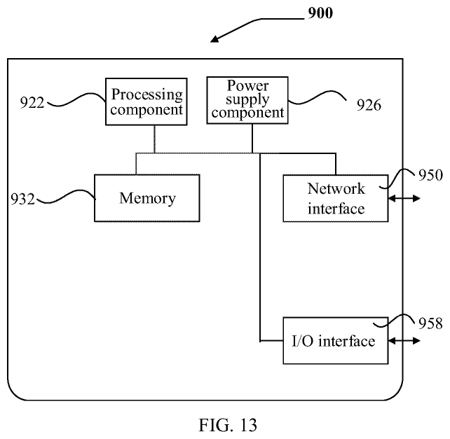

FIG. 13 is a structural schematic diagram illustrating a communication device 900 according to an embodiment of the present disclosure. For example, the communication device 900 may be provided as a network device. The communication device 900 may be a base station.

Referring to FIG. 13, the device communication 900 includes a processing component 922, which further includes one or more processors, and memory resources represented by a memory 932 for storing instructions, such as an application program, that may be executed by the processing component 922. The application program stored in the memory 932 may include one or more modules each corresponding to a set of instructions. In addition, the processing component 922 is configured to execute the instructions to perform the method as shown in any one of FIGS. 2 and 4 to 8.

The communication device 900 may further include: a power supply component 926, configured to manage power supply of the communication device 900, a wired or wireless network interface 950, configured to connect the communication device 900 to a network, and an input/output (I/O) interface 958. The communication device 900 may operate an operating system based on an operating system stored in the memory 932, such as Windows Server™, Mac OS X™, Unix™, Linux™, FreeBSD™ or the like.

In the technical solutions provided by the embodiments of the present disclosure, based on the CSI prediction result, RS measurement and/or CSI reporting is performed. In this way, the RS measurement behaviors and CSI reporting behaviors determined based on the CSI prediction result of the future time can better match the CSI prediction change so as to improve the flexibility of performing measurement and reporting, and reduce the high resource overhead and power consumption waste resulting from the low control accuracy for the measurement and reporting.

Other embodiments of the present disclosure will be readily apparent to those skilled in the art after considering the specification and practicing the contents disclosed herein. The present disclosure is intended to cover any variations, uses, modification or adaptations of the present disclosure that follow the general principles thereof and include common knowledge or conventional technical means in the art that are not disclosed in the present disclosure. The specification and examples are to be regarded as illustrative only. The true scope and spirit of the present disclosure are pointed out by the following claims.

It is to be understood that the present disclosure is not limited to the precise construction described herein and shown in the drawings, and that various modifications and changes may be made without departing from the scope thereof. The scope of the present disclosure is to be limited only by the appended claims.

1. A method for processing channel status information (CSI), performed by a terminal and comprising:
performing, based on a CSI prediction result, at least one of: reference signal (RS) measurement, or CSI reporting.

2. The method of claim 1, wherein the CSI prediction result comprises at least one of:
a valid time length of the CSI reported at a target time;
a suggested measurement period of RS; or
a suggested reporting period of CSI.

3. The method of claim 2, further comprising:
within the valid time length of the CSI reported at the target time, stopping at least one of: at least part of periodic measurement of RS, or at least part of periodic reporting of CSI;
wherein the method further comprises:
within the valid time length of the CSI reported at the target time, reporting the CSI based on indication information of a base station.

4. (canceled)

5. The method of claim 2, further comprises: transmitting the CSI prediction result to a base station.

6. The method of claim 5, wherein performing, based on the CSI prediction result, at least one of: the RS measurement, or the CSI reporting comprises:
in response to receiving a preset instruction returned by the base station in response to the CSI prediction result, performing, based on at least one of: the CSI prediction result or the preset instruction, at least one of: the RS measurement, or the CSI reporting.

7. The method of claim 5, wherein transmitting the CSI prediction result to the base station comprises:
in response to there being an available CSI reporting resource within a preset time window, reporting the CSI and the CSI prediction result;
in response to there being no available CSI reporting resource within the preset time window, reporting the CSI and the CSI prediction result based on indication information of the base station.

8. The method of claim 6, wherein performing, based on the CSI prediction result, at least one of: the RS measurement, or the CSI reporting comprises:
determining, based on at least one of: a first time of receiving the preset instruction or a second time of reporting the CSI last prior to a current time, a start time of at least one of: the RS measurement or the CSI reporting; and
performing, based on the suggested measurement period and the start time, the RS measurement, and/or performing, based on the suggested reporting period and the start time, the CSI reporting.

9. The method of claim 5, further comprising:
obtaining at least one to-be-predicted time of to-be-predicted CSI; and
determining, based on the CSI obtained by current RS measurement, a CSI prediction result corresponding to the to-be-predicted time.

10. The method of claim 5, wherein the CSI prediction result is reported to the base station by a medium access control-control element (MAC-CE), or uplink control information (UCI).

11. The method of claim 1, further comprising:
receiving an update instruction, for at least one of: a measurement period or a reporting period and based on the CSI prediction result, transmitted by a base station.

12. The method of claim 3, further comprising:
performing, by at least one of: a time domain resource or a frequency domain resource for at least one of: receiving the RS or reporting the CSI, data transmission.

13. A method for processing channel status information (CSI), performed by a base station and comprising:
obtaining a CSI prediction result, wherein the CSI prediction result is for at least one of: reference signal (RS) measurement, or CSI reporting.

14. The method of claim 13, wherein the CSI prediction result comprises at least one of:
a valid time length of the CSI reported at a target time;
a suggested measurement period of RS; or
a suggested reporting period of CSI.

15. The method of claim 13, wherein obtaining the CSI prediction result comprises:
receiving the CSI prediction result transmitted by a terminal;
wherein the method further comprises:
determining whether the CSI prediction result meets a preset condition for transmission between the terminal and the base station; and
in response to the CSI prediction result meeting the preset condition, transmitting a preset instruction for instructing the terminal to perform, based on the CSI prediction result, at least one of: the RS measurement, or the CSI reporting.

16. The method of claim 15, wherein receiving the CSI prediction result transmitted by the terminal comprises:
transmitting indication information; and
receiving CSI and the CSI prediction result reported by the terminal in response to the indication information.

17. The method of claim 13, wherein obtaining the CSI prediction result comprises:
obtaining at least one to-be-predicted time of to-be-predicted CSI; and
determining, based on currently-received CSI, a CSI prediction result corresponding to the to-be-predicted time;
wherein the method further comprises:
transmitting an update instruction, for at least one of: a measurement period or a reporting period and based on the CSI prediction result, to a terminal.

18. (canceled)

19. The method of claim 14, further comprises at least one of:
determining, based on the suggested measurement period, a transmitting period of RS and transmitting, based on the transmitting period, the RS to a terminal; or
receiving the CSI reported by the terminal based on the suggested reporting period.

20. The method of claim 19, further comprising:
performing, by at least one of: a time domain resource or a frequency domain resource for at least one of: transmitting the RS or receiving the CSI, data transmission.

21. (canceled)

22. (canceled)

23. A communication device, comprising: a processor; and a memory storing programs executable by the processor; wherein the programs, when executed by the processor, cause the processor to perform operations comprising:
performing, based on a CSI prediction result, at least one of: reference signal (RS) measurement, or CSI reporting.

24. (canceled)

25. A communication device, comprising: a processor; and a memory storing programs executable by the processor; wherein the programs, when executed by the processor, cause the processor to perform the method of claim 13.
